(19) United States
(12) Patent Application Publication
(10) Pub. No.: US 2026/0037966 A1
(43) Pub. Date: Feb. 5, 2026

(54) Method, System, and Computer Program Product for Cryptogram-Based Transactions

(71) Applicant: Visa International Service Association, San Francisco, CA (US)

(72) Inventors: Otto Williams, San Francisco, CA (US); Ranveer Raj Jain, Dubai (AE); Harsha Sathyanarayana Naga, Dubai (AE); Prasad Vasudevan Menon, Dubai (AE); Amal Jose Thomas, Dubai (AE); Stylianos Panagiotis Michaelides, Dubai (AE); Koushik Vedaraman, Dubai (AE)

(21) Appl. No.: 18/997,891

(22) PCT Filed: Jul. 31, 2023
(86) PCT No.: PCT/US2023/029058

§ 371 Date: Jan. 23, 2025

Related U.S. Application Data
(60) Provisional application No. 63/393,391, filed on Jul. 29, 2022.

(51) Int. Cl. G06Q 20/38; G06Q 20/40

(52) U.S. Cl. CPC G06Q 20/3829; G06Q 20/409

(57) ABSTRACT

A computer-implemented method may include: transmitting a public key to a merchant system, the public key of a payment device provider system; receiving a request for a prepaid amount from a user device of a user; in response to receiving the request, generating a cryptogram based on a payment device of the user, the prepaid amount, and a private key corresponding to the public key of the payment device provider system, the public key and the private key forming a public-private key pair associated with the payment device provider system; and transmitting the cryptogram to the user device, the cryptogram configured to authenticate the user device during an electronic payment transaction initiated by the user device with a merchant system.

### CROSS-REFERENCE TO RELATED APPLICATIONS

This application is the United States national phase of International Application No. PCT/US23/29058, filed Jul. 31, 2023, and claims the benefit of U.S. Provisional Application No. 63/393,391, filed Jul. 29, 2022, the disclosures of which are hereby incorporated by reference in their entireties.

### BACKGROUND

### 1. Technical Field

This disclosure relates generally to electronic payment transactions, and, in some non-limiting embodiments or aspects, to methods, systems, and computer program products for cryptogram-based transactions. The cryptogram may be generated by a module that is a component of a unified service orchestration layer hosted by the transaction processing system.

### 2. Technical Considerations

There are many technical hurdles for integrating new payment device provider systems in electronic payment processing networks. For example, for financial technology (“fintech”) entities and non-banking entities, it may be difficult to initiate a new payment device program given the number of disparate systems the entity needs to interface with in the technical environment. By way of further example, an entity that is initiating a new payment device program in an electronic payment processing network may need to communicatively network, via a plurality of separate channels, with issuer systems, electronic know-your-customer (KYC) service provider systems, bank identification number (BIN) sponsor systems, transaction service provider systems, and/or the like. Not only is a higher amount of computational resources required for integration, but the number of separate communication channels becomes duplicative and wasteful of computational resources when multiplied over additional payment device provider entities.

Moreover, many existing payment devices are capable of initiating electronic payment transactions over electronic payment processing networks, but require users initiating those payment transactions to remain at the point-of-sale device until the transaction has been authorized by the issuer, which provides the merchant with an assurance that it will be paid the transaction amount. Payment processes that allow users to present their payment devices to initiate electronic payment transactions and subsequently immediately leave the point-of-sale device without having to wait for the aforementioned issuer authorization, while still guaranteeing merchant payment, are desired.

### SUMMARY

Accordingly, provided are improved systems, methods, and computer program products for cryptogram-based transactions.

According to non-limiting embodiments or aspects, provided is a computer-implemented method that includes: transmitting, with at least one processor, a public key to a merchant system, the public key of a payment device provider system; receiving, with at least one processor, a request for a prepaid amount from a user device of a user; in response to receiving the request, generating, with at least one processor, a cryptogram based on a payment device of the user, the prepaid amount, and a private key corresponding to the public key of the payment device provider system, the public key and the private key forming a public-private key pair associated with the payment device provider system; and transmitting, with at least one processor, the cryptogram to the user device, the cryptogram configured to authenticate the user device during an electronic payment transaction initiated by the user device with a merchant system.

In some non-limiting embodiments or aspects, the computer-implemented method may further include: receiving, with the merchant system, a transaction request from the user device, the transaction request including an account identifier corresponding to the payment device and the cryptogram, the transaction request associated with the electronic payment transaction and a transaction amount; and in response to receiving the cryptogram, the merchant system: determining the payment device provider system based on at least one of the account identifier corresponding to the payment device and the cryptogram; validating the cryptogram based on the public key of the payment device provider system; and transmitting a confirmation message to the user device indicating that the electronic payment transaction has been approved.

In some non-limiting embodiments or aspects, the cryptogram may be validated without the merchant system communicating with the payment device provider system.

In some non-limiting embodiments or aspects, the computer-implemented method may further include the merchant system: determining that the transaction amount is less than or equal to the prepaid amount, where the cryptogram is validated at least partially based on the transaction amount being less than or equal to the prepaid amount.

In some non-limiting embodiments or aspects, the computer-implemented method may further include: in response to receiving the request, causing, with at least one processor, the prepaid amount to be automatically debited from a payment device provider system account associated with the user before initiation of the electronic payment transaction.

In some non-limiting embodiments or aspects, the computer-implemented method may further include: receiving, with at least one processor, a clearing request including the account identifier corresponding to the payment device, the cryptogram, and a settlement amount and/or the transaction amount; determining, with at least one processor, that the transaction amount is less than the prepaid amount by a difference; and causing, with at least one processor, the difference to automatically be credited to the payment device provider system account associated with the user.

In some non-limiting embodiments or aspects, the request may be generated and transmitted by the user device in response to receiving a message from the merchant system including the transaction amount, the transaction amount equal to the prepaid amount.

In some non-limiting embodiments or aspects, the request may be automatically generated and transmitted by the user device prior to initiation of the electronic payment transaction, the transaction amount different from the prepaid amount.

In some non-limiting embodiments or aspects, the cryptogram may be generated by a module of a transaction processing system of a transaction service provider.

In some non-limiting embodiments or aspects, the module may be a component of a unified service orchestration layer hosted by the transaction processing system, the unified service orchestration layer including a plurality of application programming interfaces (APIs) configured to facilitate communication with at least one third party system via the unified service orchestration layer.

In some non-limiting embodiments or aspects, the at least one third party system may include at least one of a third party data service provider system, a bank identification number (BIN) sponsor system, an issuer system, a transaction processing system, or any combination thereof.

In some non-limiting embodiments or aspects, the user device may communicate with the module using an application generated by the payment device provider system using a software development kit (SDK) including an interface with the unified service orchestration layer.

According to non-limiting embodiments or aspects, provided is a system including at least one processor programmed or configured to: transmit a public key to a merchant system, the public key of a payment device provider system; receive a request for a prepaid amount from a user device of a user; in response to receiving the request, generate a cryptogram based on a payment device of the user, the prepaid amount, and a private key corresponding to the public key of the payment device provider system, the public key and the private key forming a public-private key pair associated with the payment device provider system; and transmit the cryptogram to the user device, the cryptogram configured to authenticate the user device during an electronic payment transaction initiated by the user device with a merchant system.

In some non-limiting embodiments or aspects, the merchant system may be programmed or configured to: receive a transaction request from the user device, the transaction request including an account identifier corresponding to the payment device and the cryptogram, the transaction request associated with the electronic payment transaction and a transaction amount; and in response to receiving the cryptogram: determine the payment device provider system based on at least one of the account identifier corresponding to the payment device and the cryptogram; validate the cryptogram based on the public key of the payment device provider system; and transmit a confirmation message to the user device indicating that the electronic payment transaction has been approved.

In some non-limiting embodiments or aspects, the cryptogram may be validated without the merchant system communicating with the payment device provider system.

In some non-limiting embodiments or aspects, the merchant system may be programmed or configured to: determine that the transaction amount is less than or equal to the prepaid amount, where the cryptogram is validated at least partially based on the transaction amount being less than or equal to the prepaid amount.

In some non-limiting embodiments or aspects, the at least one processor may be programmed or configured to: in response to receiving the request, cause the prepaid amount to be automatically debited from a payment device provider system account associated with the user before initiation of the electronic payment transaction.

In some non-limiting embodiments or aspects, the at least one processor may be programmed or configured to: receive a clearing request including the account identifier corresponding to the payment device, the cryptogram, and a settlement amount and/or the transaction amount; determine that the transaction amount is less than the prepaid amount by a difference; and cause the difference to automatically be credited to the payment device provider system account associated with the user.

In some non-limiting embodiments or aspects, the request may be generated and transmitted by the user device in response to receiving a message from the merchant system including the transaction amount, the transaction amount equal to the prepaid amount.

In some non-limiting embodiments or aspects, the request may be automatically generated and transmitted by the user device prior to initiation of the electronic payment transaction, the transaction amount different from the prepaid amount.

In some non-limiting embodiments or aspects, the cryptogram may be generated by a module of a transaction processing system of a transaction service provider.

In some non-limiting embodiments or aspects, the module may be a component of a unified service orchestration layer hosted by the transaction processing system, the unified service orchestration layer including a plurality of application programming interfaces (APIs) configured to facilitate communication with at least one third party system via the unified service orchestration layer.

In some non-limiting embodiments or aspects, the at least one third party system may include at least one of a third party data service provider system, a bank identification number (BIN) sponsor system, an issuer system, a transaction processing system, or any combination thereof.

In some non-limiting embodiments or aspects, the user device may communicate with the module using an application generated by the payment device provider system using a software development kit (SDK) including an interface with the unified service orchestration layer.

According to non-limiting embodiments or aspects, provided is computer program product including at least one non-transitory computer-readable medium including program instructions that, when executed by at least one processor, cause the at least one processor to: transmit a public key to a merchant system, the public key of a payment device provider system; receive a request for a prepaid amount from a user device of a user; in response to receiving the request, generate a cryptogram based on a payment device of the user, the prepaid amount, and a private key corresponding to the public key of the payment device provider system, the public key and the private key forming a public-private key pair associated with the payment device provider system; and transmit the cryptogram to the user device, the cryptogram configured to authenticate the user device during an electronic payment transaction initiated by the user device with a merchant system.

In some non-limiting embodiments or aspects, the program instructions may cause the merchant system to: receive a transaction request from the user device, the transaction request including an account identifier corresponding to the payment device and the cryptogram, the transaction request associated with the electronic payment transaction and a transaction amount; and in response to receiving the cryptogram: determine the payment device provider system based on at least one of the account identifier corresponding to the payment device and the cryptogram; validate the cryptogram based on the public key of the payment device provider system; and transmit a confirmation message to the user device indicating that the electronic payment transaction has been approved.

In some non-limiting embodiments or aspects, the cryptogram may be validated without the merchant system communicating with the payment device provider system.

In some non-limiting embodiments or aspects, the program instructions may cause the merchant system to: determine that the transaction amount is less than or equal to the prepaid amount, where the cryptogram is validated at least partially based on the transaction amount being less than or equal to the prepaid amount.

In some non-limiting embodiments or aspects, the program instructions may cause the at least one processor to: in response to receiving the request, cause the prepaid amount to be automatically debited from a payment device provider system account associated with the user before initiation of the electronic payment transaction.

In some non-limiting embodiments or aspects, the program instructions may cause the at least one processor to: receive a clearing request including the account identifier corresponding to the payment device, the cryptogram, and a settlement amount and/or the transaction amount; determine that the transaction amount is less than the prepaid amount by a difference; and cause the difference to automatically be credited to the payment device provider system account associated with the user.

In some non-limiting embodiments or aspects, the request may be generated and transmitted by the user device in response to receiving a message from the merchant system including the transaction amount, the transaction amount equal to the prepaid amount.

In some non-limiting embodiments or aspects, the request may be automatically generated and transmitted by the user device prior to initiation of the electronic payment transaction, the transaction amount different from the prepaid amount.

In some non-limiting embodiments or aspects, the cryptogram may be generated by a module of a transaction processing system of a transaction service provider.

In some non-limiting embodiments or aspects, the module may be a component of a unified service orchestration layer hosted by the transaction processing system, the unified service orchestration layer including a plurality of application programming interfaces (APIs) configured to facilitate communication with at least one third party system via the unified service orchestration layer.

In some non-limiting embodiments or aspects, the at least one third party system may include at least one of a third party data service provider system, a bank identification number (BIN) sponsor system, an issuer system, a transaction processing system, or any combination thereof.

In some non-limiting embodiments or aspects, the user device may communicate with the module using an application generated by the payment device provider system using a software development kit (SDK) including an interface with the unified service orchestration layer.

According to non-limiting embodiments or aspects, provided is a computer program product including at least one non-transitory computer-readable medium including: a software development kit configured to develop a mobile application, the software development kit including at least one application programming interface configured to facilitate communication between the mobile application and a remote server, the remote server including a plurality of application programming interfaces configured to facilitate communication between the remote server and a plurality of service provider systems.

In some non-limiting embodiments or aspects, the remote server may include an orchestration layer that facilitates communication between the mobile application and the plurality of service provider systems.

Other non-limiting embodiments or aspects will be set forth in the following numbered clauses:
Clause 1: A computer-implemented method comprising: transmitting, with at least one processor, a public key to a merchant system, the public key of a payment device provider system; receiving, with at least one processor, a request for a prepaid amount from a user device of a user; in response to receiving the request, generating, with at least one processor, a cryptogram based on a payment device of the user, the prepaid amount, and a private key corresponding to the public key of the payment device provider system, the public key and the private key forming a public-private key pair associated with the payment device provider system; and transmitting, with at least one processor, the cryptogram to the user device, the cryptogram configured to authenticate the user device during an electronic payment transaction initiated by the user device with a merchant system.
Clause 2: The computer-implemented method of clause 1, further comprising: receiving, with the merchant system, a transaction request from the user device, the transaction request comprising an account identifier corresponding to the payment device and the cryptogram, the transaction request associated with the electronic payment transaction and a transaction amount; and in response to receiving the cryptogram, the merchant system: determining the payment device provider system based on at least one of the account identifier corresponding to the payment device and the cryptogram; validating the cryptogram based on the public key of the payment device provider system; and transmitting a confirmation message to the user device indicating that the electronic payment transaction has been approved.
Clause 3: The computer-implemented method of clause 1 or 2, wherein the cryptogram is validated without the merchant system communicating with the payment device provider system.
Clause 4: The computer-implemented method of any of clauses 1-3, further comprising the merchant system: determining that the transaction amount is less than or equal to the prepaid amount, wherein the cryptogram is validated at least partially based on the transaction amount being less than or equal to the prepaid amount.
Clause 5: The computer-implemented method of any of clauses 1-4, further comprising: in response to receiving the request, causing, with at least one processor, the prepaid amount to be automatically debited from a payment device provider system account associated with the user before initiation of the electronic payment transaction.
Clause 6: The computer-implemented method of any of clauses 1-5, further comprising: receiving, with at least one processor, a clearing request comprising the account identifier corresponding to the payment device, the cryptogram, and a settlement amount and/or the transaction amount; determining, with at least one processor, that the transaction amount is less than the prepaid amount by a difference; and causing, with at least one processor, the difference to automatically be credited to the payment device provider system account associated with the user.
Clause 7: The computer-implemented method of any of clauses 1-6, wherein the request is generated and transmitted by the user device in response to receiving a message from the merchant system comprising the transaction amount, the transaction amount equal to the prepaid amount.
Clause 8: The computer-implemented method of any of clauses 1-7, wherein the request is automatically generated and transmitted by the user device prior to initiation of the electronic payment transaction, the transaction amount different from the prepaid amount.
Clause 9: The computer-implemented method of any of clauses 1-8, wherein the cryptogram is generated by a module of a transaction processing system of a transaction service provider.
Clause 10: The computer-implemented method of any of clauses 1-9, wherein the module is a component of a unified service orchestration layer hosted by the transaction processing system, the unified service orchestration layer comprising a plurality of application programming interfaces (APIs) configured to facilitate communication with at least one third party system via the unified service orchestration layer.
Clause 11: The computer-implemented method of any of clauses 1-10, wherein the at least one third party system comprises at least one of a third party data service provider system, a bank identification number (BIN) sponsor system, an issuer system, a transaction processing system, or any combination thereof.
Clause 12: The computer-implemented method of any of clauses 1-11, wherein the user device communicates with the module using an application generated by the payment device provider system using a software development kit (SDK) comprising an interface with the unified service orchestration layer.
Clause 13: A system comprising at least one processor programmed or configured to: transmit a public key to a merchant system, the public key of a payment device provider system; receive a request for a prepaid amount from a user device of a user; in response to receiving the request, generate a cryptogram based on a payment device of the user, the prepaid amount, and a private key corresponding to the public key of the payment device provider system, the public key and the private key forming a public-private key pair associated with the payment device provider system; and transmit the cryptogram to the user device, the cryptogram configured to authenticate the user device during an electronic payment transaction initiated by the user device with a merchant system.
Clause 14: The system of clause 13, further comprising the merchant system programmed or configured to: receive a transaction request from the user device, the transaction request comprising an account identifier corresponding to the payment device and the cryptogram, the transaction request associated with the electronic payment transaction and a transaction amount; and in response to receiving the cryptogram: determine the payment device provider system based on at least one of the account identifier corresponding to the payment device and the cryptogram; validate the cryptogram based on the public key of the payment device provider system; and transmit a confirmation message to the user device indicating that the electronic payment transaction has been approved.
Clause 15: The system of clause 13 or 14, wherein the cryptogram is validated without the merchant system communicating with the payment device provider system.
Clause 16: The system of any of clauses 13-15, wherein the merchant system is programmed or configured to: determine that the transaction amount is less than or equal to the prepaid amount, wherein the cryptogram is validated at least partially based on the transaction amount being less than or equal to the prepaid amount.
Clause 17: The system of any of clauses 13-16, wherein the at least one processor is programmed or configured to: in response to receiving the request, cause the prepaid amount to be automatically debited from a payment device provider system account associated with the user before initiation of the electronic payment transaction.
Clause 18: The system of any of clauses 13-17, wherein the at least one processor is programmed or configured to: receive a clearing request comprising the account identifier corresponding to the payment device, the cryptogram, and a settlement amount and/or the transaction amount; determine that the transaction amount is less than the prepaid amount by a difference; and cause the difference to automatically be credited to the payment device provider system account associated with the user.
Clause 19: The system of any of clauses 13-18, wherein the request is generated and transmitted by the user device in response to receiving a message from the merchant system comprising the transaction amount, the transaction amount equal to the prepaid amount.
Clause 20: The system of any of clauses 13-19, wherein the request is automatically generated and transmitted by the user device prior to initiation of the electronic payment transaction, the transaction amount different from the prepaid amount.
Clause 21: The system of any of clauses 13-20, wherein the cryptogram is generated by a module of a transaction processing system of a transaction service provider.
Clause 22: The system of any of clauses 13-21, wherein the module is a component of a unified service orchestration layer hosted by the transaction processing system, the unified service orchestration layer comprising a plurality of application programming interfaces (APIs) configured to facilitate communication with at least one third party system via the unified service orchestration layer.
Clause 23: The system of any of clauses 13-22, wherein the at least one third party system comprises at least one of a third party data service provider system, a bank identification number (BIN) sponsor system, an issuer system, a transaction processing system, or any combination thereof.
Clause 24: The system of any of clauses 13-23, wherein the user device communicates with the module using an application generated by the payment device provider system using a software development kit (SDK) comprising an interface with the unified service orchestration layer.
Clause 25: A computer program product comprising at least one non-transitory computer-readable medium including program instructions that, when executed by at least one processor, cause the at least one processor to: transmit a public key to a merchant system, the public key of a payment device provider system; receive a request for a prepaid amount from a user device of a user; in response to receiving the request, generate a cryptogram based on a payment device of the user, the prepaid amount, and a private key corresponding to the public key of the payment device provider system, the public key and the private key forming a public-private key pair associated with the payment device provider system; and transmit the cryptogram to the user device, the cryptogram configured to authenticate the user device during an electronic payment transaction initiated by the user device with a merchant system.
Clause 26: The computer program product of clause 25, wherein the program instructions cause the merchant system to: receive a transaction request from the user device, the transaction request comprising an account identifier corresponding to the payment device and the cryptogram, the transaction request associated with the electronic payment transaction and a transaction amount; and in response to receiving the cryptogram: determine the payment device provider system based on at least one of the account identifier corresponding to the payment device and the cryptogram; validate the cryptogram based on the public key of the payment device provider system; and transmit a confirmation message to the user device indicating that the electronic payment transaction has been approved.
Clause 27: The computer program product of clause 25 or 26, wherein the cryptogram is validated without the merchant system communicating with the payment device provider system.
Clause 28: The computer program product of any of clauses 25-27, wherein the program instructions cause the merchant system to: determine that the transaction amount is less than or equal to the prepaid amount, wherein the cryptogram is validated at least partially based on the transaction amount being less than or equal to the prepaid amount.
Clause 29: The computer program product of any of clauses 25-28, wherein the program instructions cause the at least one processor to: in response to receiving the request, cause the prepaid amount to be automatically debited from a payment device provider system account associated with the user before initiation of the electronic payment transaction.
Clause 30: The computer program product of any of clauses 25-29, wherein the program instructions cause the at least one processor to: receive a clearing request comprising the account identifier corresponding to the payment device, the cryptogram, and a settlement amount and/or the transaction amount; determine that the transaction amount is less than the prepaid amount by a difference; and cause the difference to automatically be credited to the payment device provider system account associated with the user.
Clause 31: The computer program product of any of clauses 25-30, wherein the request is generated and transmitted by the user device in response to receiving a message from the merchant system comprising the transaction amount, the transaction amount equal to the prepaid amount.
Clause 32: The computer program product of any of clauses 25-31, wherein the request is automatically generated and transmitted by the user device prior to initiation of the electronic payment transaction, the transaction amount different from the prepaid amount.
Clause 33: The computer program product of any of clauses 25-32, wherein the cryptogram is generated by a module of a transaction processing system of a transaction service provider.
Clause 34: The computer program product of any of clauses 25-33, wherein the module is a component of a unified service orchestration layer hosted by the transaction processing system, the unified service orchestration layer comprising a plurality of application programming interfaces (APIs) configured to facilitate communication with at least one third party system via the unified service orchestration layer.
Clause 35: The computer program product of any of clauses 25-34, wherein the at least one third party system comprises at least one of a third party data service provider system, a bank identification number (BIN) sponsor system, an issuer system, a transaction processing system, or any combination thereof.
Clause 36: The computer program product of any of clauses 25-35, wherein the user device communicates with the module using an application generated by the payment device provider system using a software development kit (SDK) comprising an interface with the unified service orchestration layer.
Clause 37: A computer program product comprising at least one non-transitory computer-readable medium comprising: a software development kit configured to develop a mobile application, the software development kit comprising at least one application programming interface configured to facilitate communication between the mobile application and a remote server, the remote server comprising a plurality of application programming interfaces configured to facilitate communication between the remote server and a plurality of service provider systems.
Clause 38: The computer program product of clause 37, wherein the remote server comprises an orchestration layer that facilitates communication between the mobile application and the plurality of service provider systems.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for operating a unified service orchestration layer according to some non-limiting embodiments or aspects;

FIG. 2 is a schematic diagram of a system for operating a unified service orchestration layer according to some non-limiting embodiments or aspects;

FIG. 3 is a schematic diagram of a system for generating an application comprising a software development kit comprising an interface with a unified service orchestration layer according to some non-limiting embodiments or aspects;

FIG. 4 is a schematic diagram of a system for operating a unified service orchestration layer comprising a plurality of application programming interfaces according to some non-limiting embodiments or aspects;

FIG. 5 is a schematic diagram of a system for cryptogram-based transactions according to some non-limiting embodiments or aspects;

FIG. 6 is a process flow diagram of a method for cryptogram-based transactions according to some non-limiting embodiments or aspects;

FIG. 7 is a step diagram of a computer-implemented method for cryptogram-based transactions according to some non-limiting embodiments or aspects; and

FIG. 8 illustrates example components of a device used in connection with non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

An “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, etc.).

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more point-of-sale (POS) devices used by a merchant, one or more acquirer host computers used by an acquirer, one or more mobile devices used by a user, one or more computing devices used by a payment device provider system, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of payment devices managed by a transaction service provider. As used herein, the term “payment gateway system” may refer to one or more computer systems, computer devices, servers, groups of servers, and/or the like, operated by or on behalf of a payment gateway.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers programmed or configured to process online payment transactions through webpages, mobile applications, and/or the like.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices and/or components of such (e.g., processors, servers, client devices, software applications, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the disclosed subject matter are directed to systems, methods, and computer program products for operating a unified service orchestration layer. Disclosed systems and methods reduce use of computational resources required to integrate one or more payment device provider systems (e.g., systems of fintech entities, non-banking entities, money changers/exchange houses, mid-sized and/or community banks, etc.) into an electronic payment processing network, such as in an initial phase for a new payment device program. In particular, disclosed systems and methods move the computational and communicative burden from individual payment device provider systems to a centralized system including a unified service orchestration layer (USOL) (e.g., a system including a consolidated technical stack of one or more application programming interfaces (APIs), software development kits (SDKs), and/or the like). This computational savings is magnified when the payment device provider systems need to expand services to additional territories, in which different service providers (e.g., third party data service providers, BIN sponsors, issuers, etc.) may operate. Instead of creating a customized integration at the payment device provider system for each deployment in each territory, the payment device provider system may integrate once with the USOL and make little to no modifications for successive deployments. In this way, the USOL acts as a connector node for interoperability between the payment device provider system and various other entities in the electronic payment processing ecosystem, which reduces time to deployment, reduces computing resources required for integration, lowers the number of separate communication channels generated, and improves the overall efficiency of the entire processing system.

Non-limiting embodiments or aspects of the disclosed subject matter are directed to methods, systems, and computer program products for cryptogram-based transactions, such as processing electronic payment transactions using a cryptogram. Prior to processing an electronic payment transaction, the user may engage a cryptogram module to request that a prepaid amount be debited from the user account for use in the electronic payment transaction. Based on the prepaid amount being debited from the user account, the cryptogram module generates a cryptogram. The cryptogram may be based on the payment device of the user (e.g., an account identifier thereof) and/or the prepaid amount or transaction amount and/or a timestamp and/or a randomly generated number and/or identifier (as inputs) using a private key of the payment device provider system. For example, the inputs may be digitally signed (e.g., with a one-way hashing algorithm) with the private key. The user may provide the merchant system with the cryptogram along with the inputs used to generate the cryptogram using the private key to initiate the electronic payment transaction. The merchant system may validate the cryptogram using the public key of the payment device provider system, and validated transactions may be further processed to completion. Non-limiting embodiments or aspects for processing electronic payment transactions using the cryptogram-based systems and methods described herein allow for instantaneous approval of the transaction (relative to the user initiating the transaction with the cryptogram) without requiring the merchant system to communicate with the payment device provider system and/or issuer system to obtain an authorization decision, as is conventionally done in transactions processed according to the four party model (e.g., in which the cardholder, merchant, acquirer and issuer engage with the transaction processing system to process the payment). This reduces processing requirements associated with processing the electronic payment transactions during the time the user is engaging the merchant system at the merchant point-of-sale.

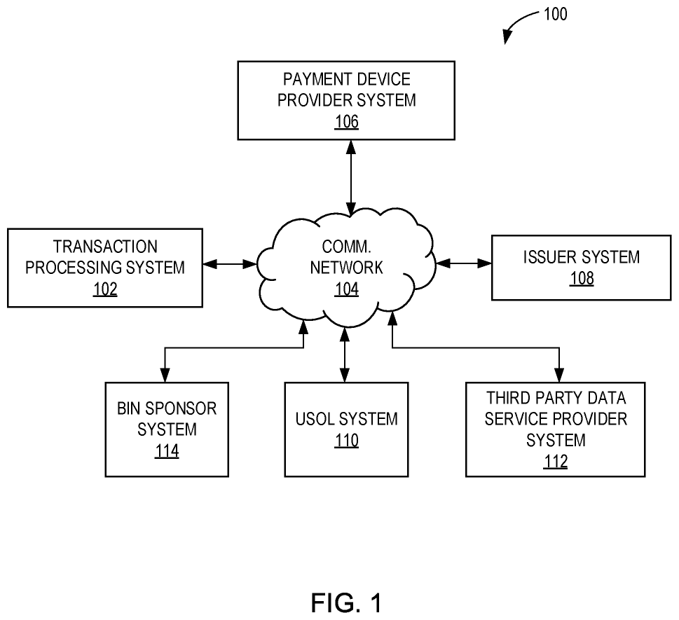

Referring to FIG. 1, shown is a system 100 for operating a USOL according to some non-limiting embodiments or aspects. The system 100 may include a transaction processing system 102, a payment device provider system 106, an issuer system 108, a USOL system 110, a third party data service provider system 112, a BIN sponsor system 114, and a communication network 104.

Transaction processing system 102 may include one or more devices configured to communicate, on behalf of a transaction service provider (e.g., Visa®), with payment device provider system 106, issuer system 108, third party data service provider system 112, USOL system 110, and/or BIN sponsor system 114, at least partially over communication network 104. Transaction processing system 102 may include a computing device, such as a server (e.g., a single server), a group of servers, and/or other like devices. Transaction processing system 102 may include or control USOL system 110. Transaction processing system 102 may provide services to payment device provider system 106 via USOL system 110.

Services that may be provided by transaction processing system 102 include user authentication services, account-to-account transaction services, risk management services, tokenization services, transaction service provider services, merchant credential management services, e-commerce services, payment gateway hosted page or API services, payment decision management services, invoice payment services, transaction control services, merchant stored card-on-file data services, stop payment services, and the like.

Payment device provider system 106 may include one or more devices configured to communicate, on behalf of a payment device provider (e.g., fintech entity, non-banking entity, etc.), with transaction processing system 102, issuer system 108, third party data service provider system 112, USOL system 110, and/or BIN sponsor system 114, at least partially over communication network 104. Payment device provider system 106 may include a computing device, such as a server (e.g., a single server), a group of servers, and/or other like devices. Payment device provider system 106 may communicate with issuer system 108, third party data service provider system 112, BIN sponsor system 114, and/or transaction processing system 102 via the USOL system 110.

Services that may be performed by the payment device provider system 106 include card issuance services, application development and management services, wallet ledger services, client lifecycle management services, data analytics services, data reporting services, issuer and/or acquirer licensing services, merchant account ledger and/or settlement services, and the like.

Issuer system 108 may include one or more devices configured to communicate, on behalf of an issuer, with transaction processing system 102, payment device provider system 106, third party data service provider system 112, USOL system 110, and/or BIN sponsor system 114, at least partially over communication network 104. Issuer system 108 may include a computing device, such as a server (e.g., a single server), a group of servers, and/or other like devices. Issuer system 108 may provide services to payment device provider system 106 via USOL system 110.

Services that may be provided by the issuer system 108 or an acquirer system 124 include acquirer and/or issuer hosting services, fraud or risk management services, dispute management services, clearing and/or settlement services, merchant data analytics services, transaction reporting services, merchant management services, payment device management services (e.g., activation/deactivation), personal identification number (PIN) set/reset services, card statement and balance display services, payment device top-up services, payment device block/unblock services, and the like.

As used herein, the “payment device provider system” may refer to a system that issues payment accounts and/or payment devices to users for initiating credit and/or debit payments. It will be understood that an issuer system may be a type of payment device provider system, but may perform one or more additional functions with respect to processing payment transactions initiated by the user (e.g., generating authorization decisions, clearing/settling transactions, dispute management, card management, fraud and/or risk management, and the like). In non-limiting embodiments, the payment device provider system may be separate from the issuer system (i.e., independent of the issuer system, such that it is not the issuer system) and may be a separate third-party entity external to a four-party model for electronic payment transactions. In non-limiting embodiments, the payment device provider system may be an issuer system.

Third party data service provider system 112 may include one or more devices configured to communicate, on behalf of a third party data service provider (e.g., a social network provider (e.g., Facebook®), a search and data provider (e.g., Google®), etc.), with transaction processing system 102, payment device provider system 106, issuer system 108, USOL system 110, and/or BIN sponsor system 114, at least partially over communication network 104. Third party data service provider system 112 may include a computing device, such as a server (e.g., a single server), a group of servers, and/or other like devices. Third party data service provider system 112 may provide services to payment device provider system 106 via USOL system 110.

Services that may be provided by the third party data service provider system 112 include anti-money laundering (AML) and/or sanction services (e.g., AML monitoring, AML case management), merchant onboarding services (e.g., merchant onboarding, merchant information management, document verification, credit score and/or underwriting capabilities), card-present transaction services (e.g., soft POS applications, soft POS backend servers, merchant POS, POS backend host), white-labeled mobile application, web application, or SDK solution provider (e.g., merchant mobile application with QR code functionality, consumer mobile application SDKs, disbursement portals, backend application for merchant application, SDK, and disbursement portal), and the like. The third party data service provider system 112 may further provide electronic know-your-customer (KYC) and/or know-your-business (KYB) services (e.g., document capture, KYC data capture, selfie capture, document validation, and the like), physical card personalization services, and/or country-specific solutions therefor. The third party data service provider system 112 may further provide logistics and/or delivery services, optional application development services, treasury service operating services, cryptocurrency exchange services, and the like.

BIN sponsor system 114 may include one or more devices configured to communicate, on behalf of a BIN sponsor (e.g., an entity that provides BINs and related services for payment device providers), with transaction processing system 102, payment device provider system 106, issuer system 108, and/or USOL system 110 at least partially over communication network 104. BIN sponsor system 114 may include a computing device, such as a server (e.g., a single server), a group of servers, and/or other like devices. BIN sponsor system 114 may provide services to payment device provider system 106 via USOL system 110.

Services that may be provided by the BIN sponsor system 114 or an acquirer system 124 include issuing BIN services, acquiring BIN services, settlement services with the payment device provider system, country-specific BIN services (e.g., enabling issuance of payment devices with multi-country payment initiation capabilities), and the like.

USOL system 110 may include one or more devices configured to communicate with, and/or facilitate communication between, transaction processing system 102, payment device provider system 106, issuer system 108, and/or third party data service provider system 112 at least partially over communication network 104. USOL system 110 may include a computing device, such as a server (e.g., a single server), a group of servers, and/or other like devices. USOL system 110 may provide one or more USOLs, including APIs, SDKs, and/or the like, by which other devices in the system 100 may communicate. References herein to communications to or from a USOL may be interpreted, in some non-limiting embodiments or aspects, to communications to or from the USOL system 110. Furthermore, in some non-limiting embodiments or aspects, the USOL system 110 may be referred to herein as sending and/or transmitting communications via the USOL. USOL system 110 may further include a data warehouse (e.g., a database system) for storing data related to USOL communications. USOL system 110 may further be associated with the communication network 104 by which other devices in the system 100 communicate. In some non-limiting embodiments or aspects, USOL system 110 may be implemented and/or administered by an entity separate from the transaction processing system 102, such as an entity working on behalf of the transaction service provider. The USOL system 110 may be a single point of contact with which the payment device provider system 106 may engage to communicate with the required components and/or systems to issue payment devices to users.

Communication network 104 may refer to any communication network, such as one or more wired and/or wireless networks. For example, communication network 104 may include a cellular network (e.g., a long-term evolution (LTER) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the internet, a fiber optic-based network, a cloud computing network, and/or the like, and/or a combination of these or other types of networks.

The system of FIG. 1 may be used to enable a user to initiate payment transactions using a payment device issued by the payment device provider system 106. The payment transactions may be electronic payment transactions. The electronic payment transactions may include credit and/or debit payment transactions, international payment transactions (e.g., cross-border transactions), outbound fund transfers (e.g., domestic and/or international), scan to pay transactions, wallet funding transactions, and/or outbound disbursement transactions.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

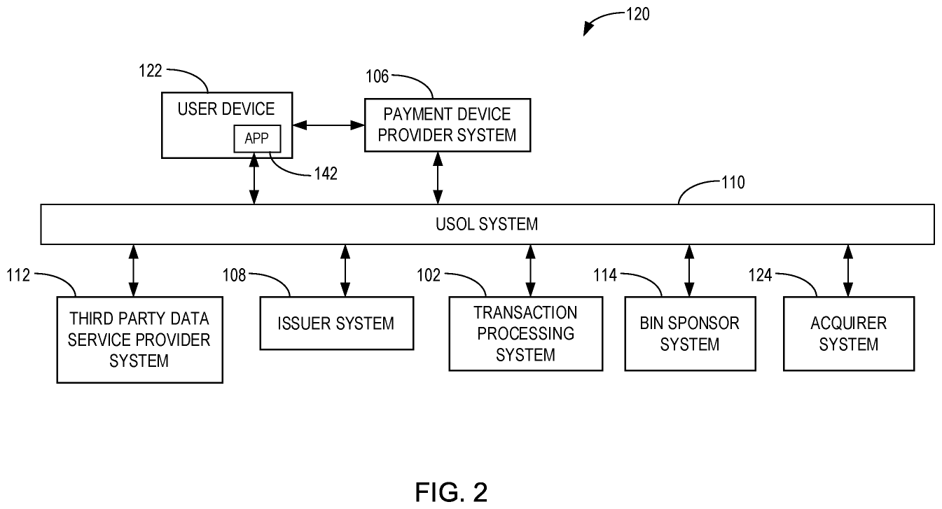

Referring to FIG. 2, a system 120 is shown for operating a USOL according to some non-limiting embodiments or aspects. The USOL system 110 may be hosted by or on behalf of the transaction processing system 102. The USOL system 110 may comprise a plurality of APIs configured to facilitate communication with at least one third party system via the USOL system 110. The at least one third party system may comprise at least one of the third party data service provider system 112, the BIN sponsor system 114, the issuer system 108, the transaction processing system 102, an acquirer system 124, or any combination thereof.

With continued reference to FIG. 2, the USOL system 110 may comprise an API configured to facilitate communication with the payment device provider system 106. Communication may be facilitated between the payment device provider system 106 and the at least one third party system via the USOL system 110 by the payment device provider system 106 engaging with the USOL system 110 via a first API and the USOL system 110 engaging the desired at least one third party system via a second API.

The payment device provider system 106 may issue a payment device to a user of a user device 122. The user device 122 may be a computing device. The payment device provider system 106 may communicate with the user device 122 to issue the payment device. The user device 122 may also communicate with the USOL system 110 to execute certain functions associated with using, administering, and/or updating the payment device. The user device 122 may engage with the USOL system 110 (and also the at least one third party system via the USOL system 110) directly or via the payment device provider system 106. For example, the user device 122 may engage with the USOL system 110 via an application 142 (e.g., a mobile application, a web-based application, and the like), such as an application 142 generated by the payment device provider system 106. The application 142 may be downloaded on the user device 122 and may be engaged by the user via a user interface of the user device 122.

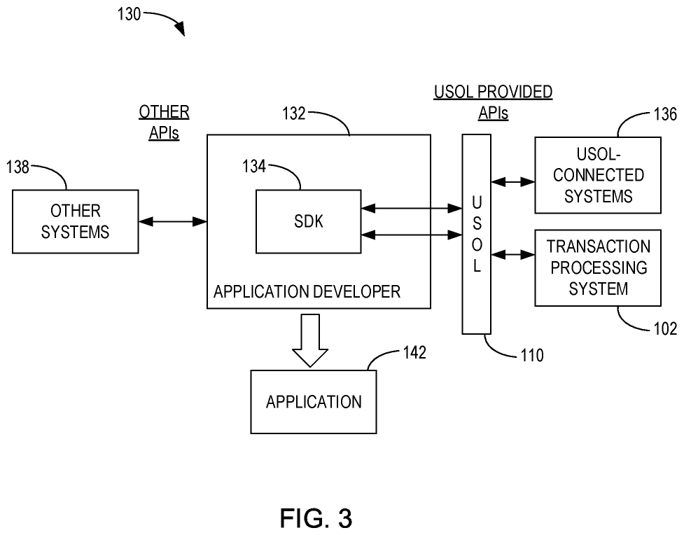

Referring to FIG. 3, a system 130 is shown for generating the application 142 (e.g., a mobile application, a web-based application, and the like) comprising a software development kit (SDK) comprising an interface with a unified service orchestration layer according to some non-limiting embodiments or aspects. In some non-limiting embodiments or aspects, the USOL system 110 may provide an application developer 132 an SDK 134. The application developer 132 may be the payment device provider system 106 and/or a system engaged by the payment device provider system 106 to generate the application 142.

The SDK 134 provided by the USOL system 110 may contain software-building tools with which the application developer 132 can generate an application 142 that engages with the USOL system 110. For example, the SDK 134 may contain one or more APIs that enable the application 142 to communicate with the USOL system 110; although it will be appreciated that the SDK 134 may contain tools beyond APIs for generating the application 142. Therefore, the application developer 132 may generate the application 142 using the SDK 134 comprising an interface with the USOL system 110.

In some non-limiting embodiments or aspects, the SDK 134 may contain an API configured to enable the application user (e.g., the user device 122) to communicate with the USOL system 110. The USOL system 110 may comprise a plurality of APIs (as previously described) that enables the user device 122 to communicate with the transaction processing system 102 and/or other USOL-connected systems 136 via the USOL system 110. The other USOL-connected systems 136 may include systems separate from the transaction processing system 102 (of the transaction service provider), which may include at least one of the third party data service provider system 112, the BIN sponsor system 114, the issuer system 108, the acquirer system 124, or any combination thereof.

In some non-limiting embodiments or aspects, the SDK 134 may contain a plurality of APIs configured to enable the application user (e.g., the user device 122) to communicate directly with the transaction processing system 102 and/or other USOL-connected systems 136, for example, without engaging with the USOL system 110.

With continued reference to FIG. 3, the application developer 132 may generate the application 142 comprising one or more APIs not included in the SDK 134, and the API may be configured to enable the user device 122 to communicate with at least one other system 138, the other system 138 being separate from the transaction processing system 102 and USOL-connected systems 136. The other systems 138 may comprise systems specific to the processes and/or offerings of the payment device provider system 106.

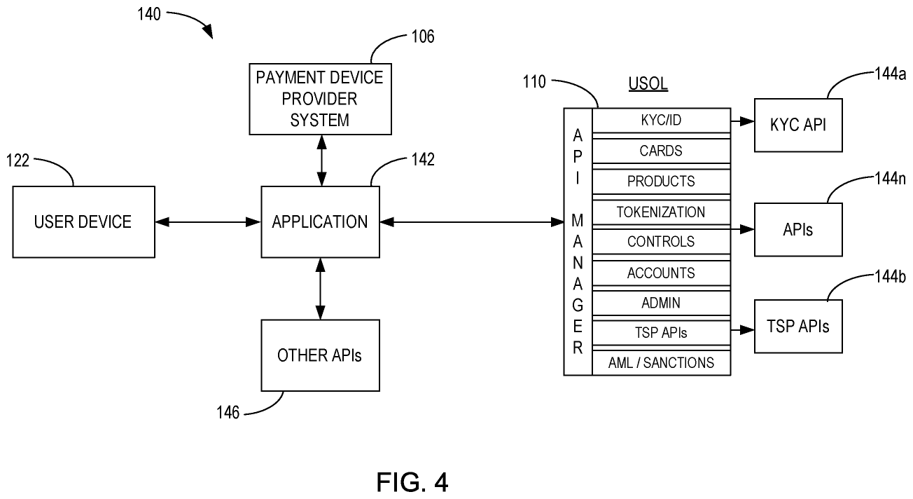

Referring to FIG. 4, a system 140 is shown for operating a USOL comprising a plurality of APIs according to some non-limiting embodiments or aspects. The user device 122 may engage the application 142 generated by the payment device provider system 106. The user device 122 may engage other APIs 146 of the application 142 to communicate with the other systems 138 (from FIG. 3) as previously described.

The user device 122 may engage an API of the application 142 to communicate with the USOL system 110. The user device 122 may communicate at least one request message to the USOL system 110 using the API of the application 142. The request message may contain a requested action, and the requested action may comprise an action executed by at least one system with which the USOL system 110 is in communication. For example, the requested action may be associated with function associated with “know your customer” (KYC) or other user identifying function, with a function associated with the payment device (e.g., card), with a function associated with a product associated with the payment device, with a function associated with a token associated with the payment device, with a function associated with controlling use of the payment device, with a function associated with managing and/or updating the user's account, with a function associated with administering the user's account, with a function executed by the transaction service provider, with a function associated with anti-money laundering (AML), and the like. Each function may be associated with one or more APIs. An API may be associated with one or more functions.

By way of example, in FIG. 4, an API (e.g., KYC API 144a) may be executed in response to the request message requesting an action associated with the function associated with “know your customer” (KYC). An API (e.g., TSP APIs) 144b) may be executed in response to the request message requesting an action associated with a function executed by the transaction service provider. One or more further APIs 144n may be executed in response to the request message requesting some other action corresponding to an API of the USOL system 110.

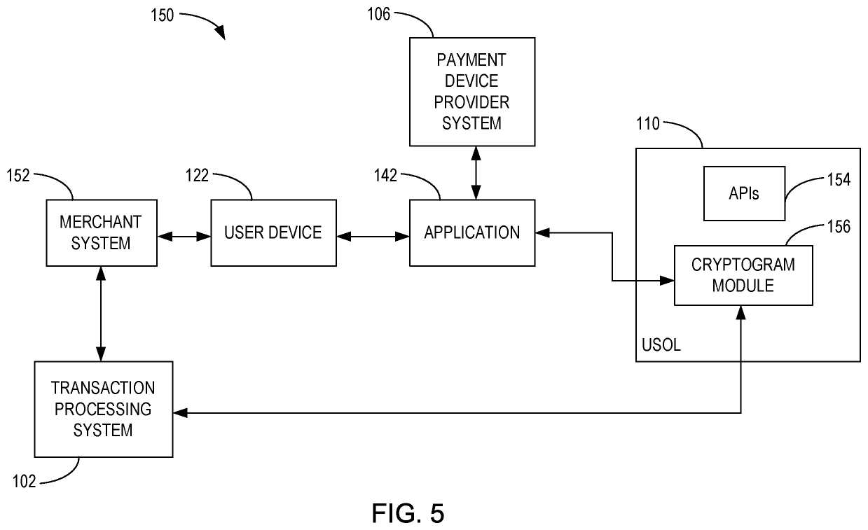

Referring to FIG. 5, a system 150 is shown for cryptogram-based transactions according to some non-limiting embodiments or aspects. In some non-limiting embodiments or aspects, the USOL system 110 may comprise APIs 154, which correspond to the APIs shown and described in FIGS. 3 and 4. For processing cryptogram-based transactions using payment devices configured to initiate cryptogram-based transactions (as described hereinafter), the USOL system 110 may further comprise a cryptogram module 156 as a component thereof. Alternatively, cryptogram-based transactions may be processed using a cryptogram module 156 that is not a component of the USOL system 110 (e.g., is separate from the USOL system 110), and the cryptogram module 156 may be a component of a system not having all of some of the capabilities of the USOL system 110 as described herein. The cryptogram module 156 may be operated by or on behalf of the transaction processing system 102 of the transaction service provider.

With continued reference to FIG. 5, in some non-limiting embodiments or aspects, the cryptogram module 156 may determine a public key associated with the payment device provider system 106, the public key corresponding to a private key associated with the payment device provider system 106, the public key and private key forming a public-private key pair associated with the payment device provider system 106. The public-private key pair may be configured for use in the processing of cryptogram-based electronic payment transactions initiated using a payment device issued by the payment device provider system 106. The cryptogram module 156 may determine the public key by generating the public key (and/or private key) for the payment device provider system 106. The cryptogram module 156 may determine the public key by receiving the public key (and/or private key) from the payment device provider system 106. Each bank identification number (BIN) of the payment device provider system 106 may have its own public/private key, or a group of BINs for the payment device provider system 106 may have a common public/private key, such that the payment device provider system 106 may have one or more public/private keys.

The cryptogram module 156 may communicate the public key associated with the payment device provider system 106 to the transaction processing system 102. The transaction processing system 102 may communicate the received public key associated with the payment device provider system 106 to one or more merchant systems 152 (and/or an acquirer system thereof (throughout)) with which the user of the payment device (associated with the user device 122) may engage in cryptogram-based payment transactions. The transaction processing system 102 and/or the one or more merchant systems 152 may store the received public key in a database in association with the payment device provider system 106.

With continued reference to FIG. 5, the merchant system 152 and the user associated with the user device 122 may engage in a cryptogram-based electronic payment transaction for goods and/or services offered by the merchant of the merchant system 152. The merchant system 152 may communicate a transaction amount to the user, such as by displaying the transaction amount on a user interface on a device at a point-of sale, by transmitting a message to the user device 122 containing the transaction amount, and the like.

The user device 122 may communicate a request for a prepaid amount to the cryptogram module 156 (e.g., via the application 142 as previously described). In some non-limiting embodiments or aspects, the request for the prepaid amount is generated and transmitted by the user device 122 in response to receiving a transaction amount from the merchant system 152, and the transaction amount may be equal to the prepaid amount.

In some alternative non-limiting embodiments or aspects, the request for the prepaid amount may be generated and transmitted by the user device 122 prior to initiation of the electronic payment transaction and/or receiving the transaction amount from the merchant system 152. For example, the user may desire to always keep a predetermined prepaid amount (e.g., $10) ready for a cryptogram-based transaction, such that the request for the prepaid amount may be automatically generated and transmitted to the cryptogram module 156 by the user device 122 when the prepaid amount ready for a cryptogram-based transaction falls below the predetermined prepaid amount. In such examples, the transaction amount may be different than the prepaid amount.

In response to receiving the request, the cryptogram module 156 may cause the prepaid amount to be automatically debited from a payment device provider system account associated with the user before initiation of the electronic payment transaction using the cryptogram. For example, the prepaid amount may automatically be debited from the payment device provider system account associated with the user to a general and/or user-specific account controlled by the transaction processing system 102.

With continued reference to FIG. 5, in response to receiving the request for the prepaid amount (and/or in response to the debiting of the prepaid amount from the payment device provider system account associated with the user), the cryptogram module 156 may generate a cryptogram. The cryptogram may be generated by the cryptogram module 156 based on an account identifier corresponding to the payment device of the user initiating the cryptogram-based electronic payment transaction and/or the prepaid amount and/or the transaction amount and/or a timestamp and/or a randomly generated number and/or identifier (as inputs) using the private key associated with the payment device provider system 106.

The cryptogram generated by the cryptogram module 156 may be transmitted to the user device 122. The cryptogram may be configured to authenticate the user device 122 during an electronic payment transaction initiated by the user device 122 with a merchant system 152.

With continued reference to FIG. 5, the user device 122 may transmit a transaction request to the merchant system 152. The transaction request may comprise the account identifier corresponding to the payment device and the cryptogram. The transaction request may also comprise the prepaid amount and/or the transaction amount and/or the timestamp and/or the randomly generated number and/or identifier. The transaction request may be communicated to the merchant system 152 using any suitable communication means. For example, the transaction request may be communicated to the merchant system 152 using a contactless transceiver or receiver, such as via Bluetooth®, near-field communication (NFC), radio frequency identification (RFID), and/or the like. In some non-limiting embodiments, the transaction request may be communicated by a user device-generated QR code.

In response to receiving the cryptogram, the merchant system 152 may determine the payment device provider system 106 associated with the payment transaction based on at least one of the account identifier corresponding to the payment device and the cryptogram. The public key associated with the payment device provider system 106 may, in response, be retrieved by the merchant system 152.

Using the retrieved public key, the merchant system 152 may validate the cryptogram. The cryptogram may be validated based on data contained in the transaction request (e.g., at least one of the account identifiers corresponding to the payment device and/or the prepaid amount and/or the transaction amount and/or a timestamp and/or a randomly generated number and/or identifier) using the public key. The cryptogram generation and/or validation may be executed using an RSA signature generation and validation algorithm. To validate the cryptogram, the merchant system 152 may retrieve the public key associated with the payment device provider system 106, decrypt the cryptogram with the public key to determine a hash value, compute the hash value with the inputs (e.g., at least one of the account identifiers corresponding to the payment device and/or the prepaid amount and/or the transaction amount and/or a timestamp and/or a randomly generated number and/or identifier), and match the computed hash to the decrypted hash.

The merchant system 152 may confirm that the transaction should proceed based on the result of validating the cryptogram. The confirmation may indicate that the user has a prepaid amount exceeding or equal to the transaction amount such that authorization (e.g., online communication with the acquirer system 124, the transaction processing system 102, and/or the issuer system 108 for authorization) of the payment transaction with the payment device provider system 106 can be avoided while the user is at the point-of-sale device. The merchant system 152 may determine that the prepaid amount is less than the transaction amount, which may result in the merchant system 152 going online to the payment device provider system 106 for an online transaction authorization through the acquirer system 124, the transaction processing system 102, and the issuer system 108.

The cryptogram may be validated while the merchant system 152 is offline (relative to the electronic payment network including the acquirer system 124, the transaction processing system 102, and the issuer system 108). The cryptogram may be validated without the merchant system 152 communicating with the payment device provider system 106.

The merchant system 152 may transmit a confirmation message to the user device 122 indicating that the cryptogram-based electronic payment transaction has been approved. The payment transaction with respect to the user may be completed at this time such that the user may depart from the point-of-sale without providing any further data or waiting for any further authorizations. Moreover, at this time, the merchant may be guaranteed the funds of the payment transaction due to the transfer of the prepaid amount from the user's account. The transaction may then proceed to clearing and settling without intervention of the user.

With continued reference to FIG. 5, the merchant system 152 may transmit a clearing request comprising a clearing file to the transaction processing system 102 to initiate clearing and settlement of the payment transaction. The clearing file may contain at least one of the account identifier corresponding to the payment device, the cryptogram, and a settlement amount and/or the transaction amount. The settlement amount may comprise the transaction amount and/or a subset of the transaction amount to be transferred to an account of the merchant system 152. The clearing file may be transmitted from the transaction processing system 102 to the cryptogram module 156. The cryptogram module may compare the settlement amount in the clearing file to the prepaid amount to determine whether the transaction amount and the prepaid amount are equal.

In response to determining that the transaction amount and the prepaid amount are not equal, the cryptogram module 156 may determine that the transaction amount is less than the prepaid amount by a difference. Based on the transaction amount being less than the transaction amount by the difference, the cryptogram module 156 may cause the difference to automatically be credited to the payment device provider system account associated with the user. For example, the difference may automatically be credited to the payment device provider system account associated with the user from a general and/or user-specific account controlled by the transaction processing system 102.

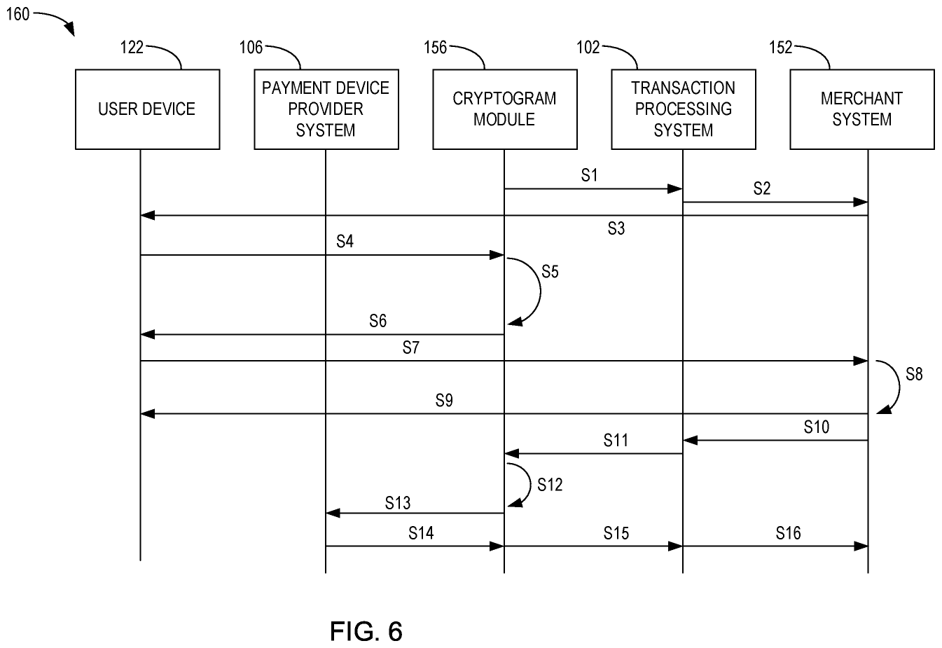

Referring to FIG. 6, a method 160 is shown for cryptogram-based transactions according to some non-limiting embodiments or aspects. It will be appreciated that one or more steps of method 160 may be executed automatically and/or in response to a preceding step. Further, non-limiting embodiments may include additional, fewer, and/or a different order of steps.

At a step S1, the method 160 may include the cryptogram module 156 communicating the public key associated with the payment device provider system 106 to the transaction processing system 102.

At a step S2, the method 160 may include the transaction processing system 102 communicating the received public key associated with the payment device provider system 106 to the merchant system 152 (and/or an acquirer system thereof (throughout)).

At a step S3, the method 160 may include the merchant system 152 and the user associated with the user device 122 engaging in a cryptogram-based electronic payment transaction for goods and/or services offered by the merchant of the merchant system 152, and the merchant system 152 may communicate a transaction amount to the user device 122.

At a step S4, the method 160 may include the user device 122 communicating a request for a prepaid amount to the cryptogram module 156.

At a step S5, the method 160 may include, in response to receiving the request for the prepaid amount, the cryptogram module 156 generating a cryptogram based on an account identifier corresponding the payment device of the user initiating the cryptogram-based electronic payment transaction and/or the prepaid amount and/or the transaction amount and/or a timestamp and/or a randomly generated number and/or identifier (as inputs) using the private key associated with the payment device provider system 106. The cryptogram module 156 may cause the prepaid amount to be automatically debited from a payment device provider system account associated with the user before initiation of the electronic payment transaction.

At a step S6, the method 160 may include the cryptogram module 156 transmitting the generated cryptogram to the user device 122. The cryptogram may be configured to authenticate the user device 122 during an electronic payment transaction initiated by the user device 122 with the merchant system 152.

At a step S7, the method 160 may include the user device 122 transmitting a transaction request to the merchant system 152. The transaction request may comprise the account identifier corresponding to the payment device and the cryptogram. The transaction request may also comprise the prepaid amount and/or the transaction amount and/or the timestamp and/or the randomly generated number and/or identifier (e.g., the inputs for generating the cryptogram).

At a step S8, the method 160 may include the merchant system 152 validating the cryptogram based on data contained in the transaction request (e.g., at least one of the account identifier corresponding to the payment device and/or the prepaid amount and/or the transaction amount and/or the timestamp and/or the randomly generated number and/or identifier) using the public key. The merchant system 152 may confirm that transaction should proceed based on the result of validating the cryptogram.

At a step S9, the method 160 may include the merchant system 152 transmitting a confirmation message to the user device 122 indicating that the cryptogram-based electronic payment transaction has been approved.

At a step S10, the method 160 may include the merchant system 152 transmitting a clearing request comprising a clearing file to the transaction processing system 102 to initiate clearing and settlement of the payment transaction. The clearing file may contain at least one of the account identifier corresponding to the payment device, the cryptogram, and a settlement amount and/or the transaction amount.

At a step S11, the method 160 may include the transaction processing system 102 transmitting the clearing file to the cryptogram module 156.

At a step S12, the method 160 may include the cryptogram module 156 comparing the transaction amount in the clearing file to the prepaid amount to determine that the transaction amount is less than the prepaid amount by a difference.

At a step S13, the method 160 may include the cryptogram module 156 causing the difference to automatically be credited to the payment device provider system account associated with the user.

At a step S14, the method 160 may include the payment device provider system 106 transmitting a refund completion message to the cryptogram module 156 indicating that the difference has been successfully credited to the payment device provider system account associated with the user.

At a step S15, the method 160 may include the cryptogram module 156 settling with the transaction processing system 102 by transferring the settlement amount (retained by the cryptogram module 156 and not credited back to the payment device provider system account associated with the user) to an account of the transaction processing system 102.

At a step S16, the method 160 may include the transaction processing system 102 settling with the merchant system 152 by transferring the settlement amount to an account of the merchant system 152.

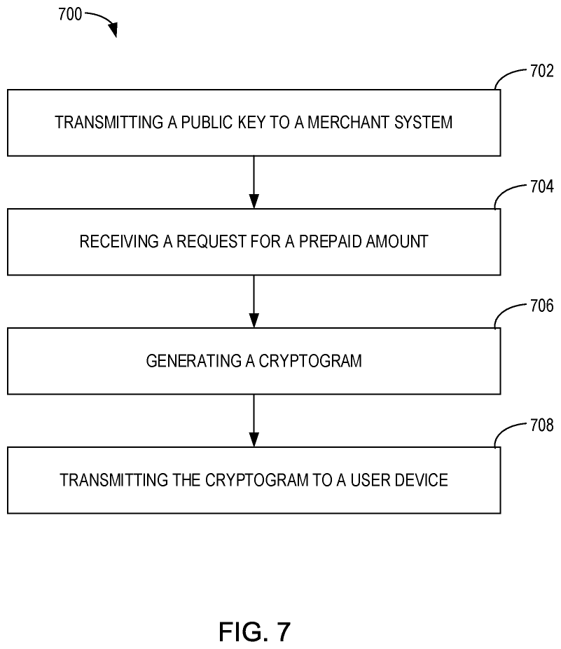

Referring to FIG. 7, a computer-implemented method 700 is shown for cryptogram-based transactions according to some non-limiting embodiments or aspects. It will be appreciated that one or more steps of method 700 may be executed automatically and/or in response to a preceding step. Further, non-limiting embodiments may include additional, fewer, and/or a different order of steps.

At a step 702, the method 700 may include transmitting, with at least one processor (e.g., with the cryptogram module 156 of USOL system 110), a public key to a merchant system, the public key of a payment device provider system.

At a step 704, the method 700 may include receiving, with at least one processor (e.g., with the cryptogram module 156 of USOL system 110), a request for a prepaid amount from a user device of a user.

At a step 706, the method 700 may include, in response to receiving the request, generating, with at least one processor (e.g., with the cryptogram module 156 of USOL system 110), a cryptogram based on a payment device of the user, the prepaid amount, and a private key corresponding to the public key of the payment device provider system, the public key and the private key forming a public-private key pair associated with the payment device provider system.

At a step 708, the method 700 may include transmitting, with at least one processor (e.g., with the cryptogram module 156 of USOL system 110), the cryptogram to the user device, the cryptogram configured to authenticate the user device during an electronic payment transaction initiated by the user device with a merchant system.

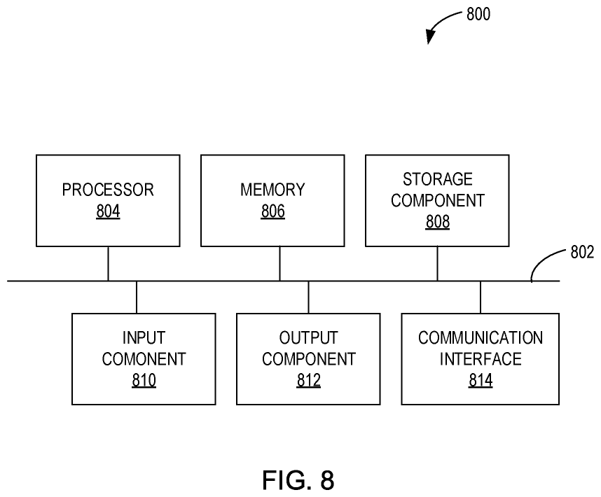

Referring now to FIG. 8, shown is a diagram of example components of a device 800 according to non-limiting embodiments or aspects. Device 800 may correspond to one or more devices of transaction processing system 102, communication network 104, payment device provider system 106, issuer system 108, USOL system 110, third party data service provider system 112, BIN sponsor system 114, user device 122, acquirer system 124, application developer 132, USOL-connected systems 136, other systems 138, merchant system 152, and/or cryptogram module as an example. In some non-limiting embodiments or aspects, such systems or devices in FIGS. 1-6 may include at least one device 800 and/or at least one component of device 800. The number and arrangement of components shown in FIG. 8 are provided as an example. In some non-limiting embodiments or aspects, device 800 may include additional components, fewer components, different components, or differently arranged components than those shown in FIG. 8. Additionally, or alternatively, a set of components (e.g., one or more components) of device 800 may perform one or more functions described as being performed by another set of components of device 800.

As shown in FIG. 8, device 800 may include bus 802, processor 804, memory 806, storage component 808, input component 810, output component 812, and communication interface 814. Bus 802 may include a component that permits communication among the components of device 800. In some non-limiting embodiments or aspects, processor 804 may be implemented in hardware, firmware, or a combination of hardware and software. For example, processor 804 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 806 may include random access memory (RAM), read only memory (ROM), and/or another type of dynamic or static storage device (e.g., flash memory, magnetic memory, optical memory, etc.) that stores information and/or instructions for use by processor 804. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

With continued reference to FIG. 8, storage component 808 may store information and/or software related to the operation and use of device 800. For example, storage component 808 may include a hard disk (e.g., a magnetic disk, an optical disk, a magneto-optic disk, a solid state disk, etc.) and/or another type of computer-readable medium. Input component 810 may include a component that permits device 800 to receive information, such as via user input (e.g., a touch screen display, a keyboard, a keypad, a mouse, a button, a switch, a microphone, etc.). Additionally, or alternatively, input component 810 may include a sensor for sensing information (e.g., a global positioning system (GPS) component, an accelerometer, a gyroscope, an actuator, etc.). Output component 812 may include a component that provides output information from device 800 (e.g., a display, a speaker, one or more light-emitting diodes (LEDs), etc.). Communication interface 814 may include a transceiver-like component (e.g., a transceiver, a separate receiver and transmitter, etc.) that enables device 800 to communicate with other devices, such as via a wired connection, a wireless connection, or a combination of wired and wireless connections. Communication interface 814 may permit device 800 to receive information from another device and/or provide information to another device. For example, communication interface 814 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 800 may perform one or more processes described herein. Device 800 may perform these processes based on processor 804 executing software instructions stored by a computer-readable medium, such as memory 806 and/or storage component 808. A computer-readable medium may include any non-transitory memory device. A memory device includes memory space located inside of a single physical storage device or memory space spread across multiple physical storage devices. Software instructions may be read into memory 806 and/or storage component 808 from another computer-readable medium or from another device via communication interface 814. When executed, software instructions stored in memory 806 and/or storage component 808 may cause processor 804 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method comprising:
transmitting, with at least one processor, a public key to a merchant system, the public key of a payment device provider system;
receiving, with at least one processor, a request for a prepaid amount from a user device of a user;
in response to receiving the request, generating, with at least one processor, a cryptogram based on a payment device of the user, the prepaid amount, and a private key corresponding to the public key of the payment device provider system, the public key and the private key forming a public-private key pair associated with the payment device provider system; and
transmitting, with at least one processor, the cryptogram to the user device, the cryptogram configured to authenticate the user device during an electronic payment transaction initiated by the user device with a merchant system.

2. The computer-implemented method of claim 1, further comprising:
receiving, with the merchant system, a transaction request from the user device, the transaction request comprising an account identifier corresponding to the payment device and the cryptogram, the transaction request associated with the electronic payment transaction and a transaction amount; and
in response to receiving the cryptogram, the merchant system:
determining the payment device provider system based on at least one of the account identifier corresponding to the payment device and the cryptogram;
validating the cryptogram based on the public key of the payment device provider system; and
transmitting a confirmation message to the user device indicating that the electronic payment transaction has been approved.

3. The computer-implemented method of claim 2, wherein the cryptogram is validated without the merchant system communicating with the payment device provider system.

4. The computer-implemented method of claim 2, further comprising the merchant system:
determining that the transaction amount is less than or equal to the prepaid amount, wherein the cryptogram is validated at least partially based on the transaction amount being less than or equal to the prepaid amount.

5. The computer-implemented method of claim 2, further comprising:
in response to receiving the request, causing, with at least one processor, the prepaid amount to be automatically debited from a payment device provider system account associated with the user before initiation of the electronic payment transaction.

6. The computer-implemented method of claim 5, further comprising:
receiving, with at least one processor, a clearing request comprising the account identifier corresponding to the payment device, the cryptogram, and a settlement amount and/or the transaction amount;
determining, with at least one processor, that the transaction amount is less than the prepaid amount by a difference; and
causing, with at least one processor, the difference to automatically be credited to the payment device provider system account associated with the user.

7. The computer-implemented method of claim 2, wherein the request is generated and transmitted by the user device in response to receiving a message from the merchant system comprising the transaction amount, the transaction amount equal to the prepaid amount.

8. The computer-implemented method of claim 2, wherein the request is automatically generated and transmitted by the user device prior to initiation of the electronic payment transaction, the transaction amount different from the prepaid amount.

9. The computer-implemented method of claim 1, wherein the cryptogram is generated by a module of a transaction processing system of a transaction service provider.

10. The computer-implemented method of claim 9, wherein the module is a component of a unified service orchestration layer hosted by the transaction processing system, the unified service orchestration layer comprising a plurality of application programming interfaces (APIs) configured to facilitate communication with at least one third party system via the unified service orchestration layer.

11. The computer-implemented method of claim 10, wherein the at least one third party system comprises at least one of a third party data service provider system, a bank identification number (BIN) sponsor system, an issuer system, a transaction processing system, or any combination thereof.

12. The computer-implemented method of claim 10, wherein the user device communicates with the module using an application generated by the payment device provider system using a software development kit (SDK) comprising an interface with the unified service orchestration layer.

13. A system comprising at least one processor programmed or configured to:
transmit a public key to a merchant system, the public key of a payment device provider system;
receive a request for a prepaid amount from a user device of a user;
in response to receiving the request, generate a cryptogram based on a payment device of the user, the prepaid amount, and a private key corresponding to the public key of the payment device provider system, the public key and the private key forming a public-private key pair associated with the payment device provider system; and
transmit the cryptogram to the user device, the cryptogram configured to authenticate the user device during an electronic payment transaction initiated by the user device with a merchant system.

14. The system of claim 13, further comprising the merchant system programmed or configured to:
receive a transaction request from the user device, the transaction request comprising an account identifier corresponding to the payment device and the cryptogram, the transaction request associated with the electronic payment transaction and a transaction amount; and
in response to receiving the cryptogram:
determine the payment device provider system based on at least one of the account identifier corresponding to the payment device and the cryptogram;
validate the cryptogram based on the public key of the payment device provider system; and
transmit a confirmation message to the user device indicating that the electronic payment transaction has been approved.

15. The system of claim 14, wherein the cryptogram is validated without the merchant system communicating with the payment device provider system.

16. The system of claim 14, wherein the merchant system is programmed or configured to:
determine that the transaction amount is less than or equal to the prepaid amount, wherein the cryptogram is validated at least partially based on the transaction amount being less than or equal to the prepaid amount.

17. The system of claim 14, wherein the at least one processor is programmed or configured to:
in response to receiving the request, cause the prepaid amount to be automatically debited from a payment device provider system account associated with the user before initiation of the electronic payment transaction.

18. The system of claim 17, wherein the at least one processor is programmed or configured to:
receive a clearing request comprising the account identifier corresponding to the payment device, the cryptogram, and a settlement amount and/or the transaction amount;
determine that the transaction amount is less than the prepaid amount by a difference; and
cause the difference to automatically be credited to the payment device provider system account associated with the user.

19. The system of claim 14, wherein the request is generated and transmitted by the user device in response to receiving a message from the merchant system comprising the transaction amount, the transaction amount equal to the prepaid amount.

20. A computer program product comprising at least one non-transitory computer-readable medium comprising:
a software development kit configured to develop a mobile application, the software development kit comprising at least one application programming interface configured to facilitate communication between the mobile application and a remote server, the remote server comprising a plurality of application programming interfaces configured to facilitate communication between the remote server and a plurality of service provider systems.
